(19) United States
(12) Patent Application Publication
(10) Pub. No.: US 2024/0217613 A1
(43) Pub. Date: Jul. 4, 2024

(54) BICYCLE OPERATING DEVICE

(71) Applicant: AD-II Engineering Inc., Taichung City (TW)

(72) Inventor: KAI-HUNG HU, Taichung City (TW)

(21) Appl. No.: 18/091,158

(22) Filed: Dec. 29, 2022

(51) Int. Cl. B62K 23/06; B62L 3/02; B62M 25/04; F15B 15/14

(52) U.S. Cl. CPC B62K 23/06; B62L 3/023; B62M 25/04; F15B 15/1428; F15B 15/1447

(57) ABSTRACT

A bicycle operating device includes a housing, a control unit, a speed shifting unit and a fluid pressure generating assembly. The housing includes a grip portion. The grip portion has a first end portion and a second end portion. The control unit is rotatably connected to the housing. The speed shifting unit is disposed on the housing. The speed shifting unit includes a reel, a shaft and at least one lever. The fluid pressure generating assembly includes a cylinder and a piston assembly. The control unit drives the piston assembly to move relative to the cylinder to generate a control fluid pressure, the cylinder is disposed on the housing and adjacent to the first end portion, the reservoir is located above the cylinder, and the piston assembly is movable along a cylinder axis of the cylinder.

### BACKGROUND OF THE INVENTION

### Field of the Invention

The present invention relates to a bicycle operating device.

### Description of the Prior Art

A speed shifting device for a bicycle is used to change the gear ratio to meet the needs of low-speed or high-speed riding. The speed shifting device is controlled by operating a speed operating device on the bicycle bended handlebar, such as one disclosed in TW 1391292. This conventional speed operating device performs the controlling of speed changing by swinging the brake lever; however, it is easy to accidentally shift the gear ratio when braking, or easy to accidentally brake during shifting of the gear ratio. In addition, this conventional speed operating device for bended handlebar also has an insufficient braking force since it only relies on that the brake lever to pull the brake cable.

The present invention is, therefore, arisen to obviate or at least mitigate the above-mentioned disadvantages.

### SUMMARY OF THE INVENTION

The main object of the present invention is to provide a bicycle operating device which not only provides a large braking force but also prevents the brake lever from being unintentionally pressed.

To achieve the above and other objects, a bicycle operating device configured to be mounted to a bended handlebar of a bicycle frame is provided, including: a housing, extending in a first direction, the housing including a grip portion, the grip portion including a first end portion and a second end portion, an attachment portion being disposed on a first end portion of the grip portion; a control unit, rotatably connected to the housing and adjacent to the first end portion; a speed shafting unit, disposed on the housing, including a reel, a shaft and at least one lever, the reel being rotatable about a rotation axis; a fluid pressure generating assembly, including a cylinder, a piston assembly and a reservoir, wherein the control unit drives the piston assembly to move relative to the cylinder to generate a control fluid pressure, the cylinder is disposed on the housing and adjacent to the first end portion, the reservoir is located above the cylinder, and the piston assembly is movable along a cylinder axis of the cylinder; wherein the cylinder axis and the rotation axis define a first included angle; wherein the first included angle smaller than 20 degrees; or wherein the grip portion includes an inclined surface adjacent to the second end portion, and the inclined surface and the cylinder axis define a second included angle ranging from 120 degrees to 160 degrees; or wherein the cylinder axis and the rotation axis define a first included angle smaller than 20 degrees, and the grip portion includes an inclined surface adjacent to the second end portion, and the inclined surface and the cylinder axis define a second included angle ranging from 120 degrees to 160 degrees.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is another stereogram of a preferable embodiment of the present invention;

FIG. 3 is a cross-sectional view of FIG. 2;

FIG. 4 is a partial enlargement of FIG. 3;

FIG. 5 is a lateral side view of a preferable embodiment of the present invention;

FIG. 6 is a lateral side view of FIG. 2; and

FIG. 7 is a rear side view of a preferable embodiment of the present invention.

### DETAILED DESCRIPTION OF THE PREFERRED EMBODIMENTS

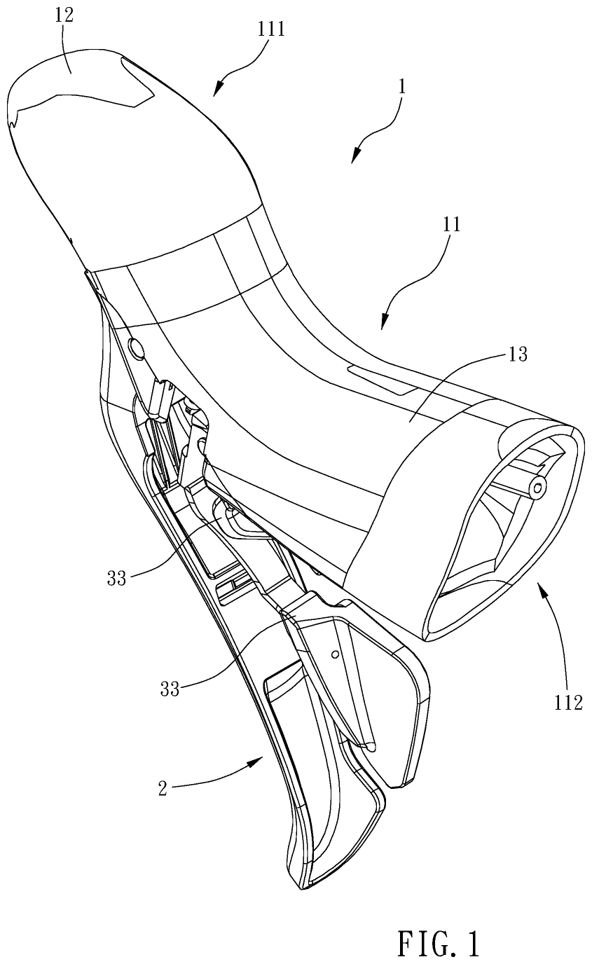

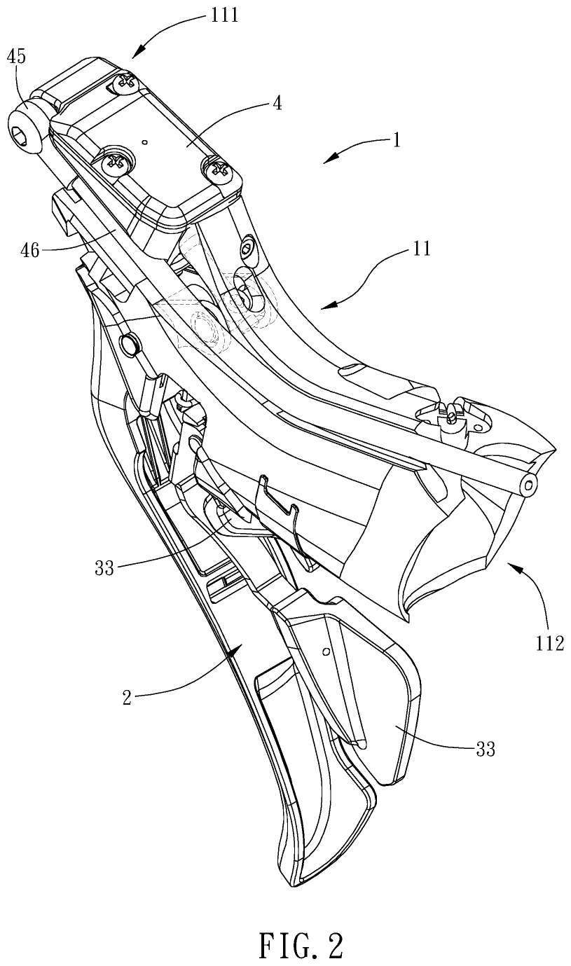

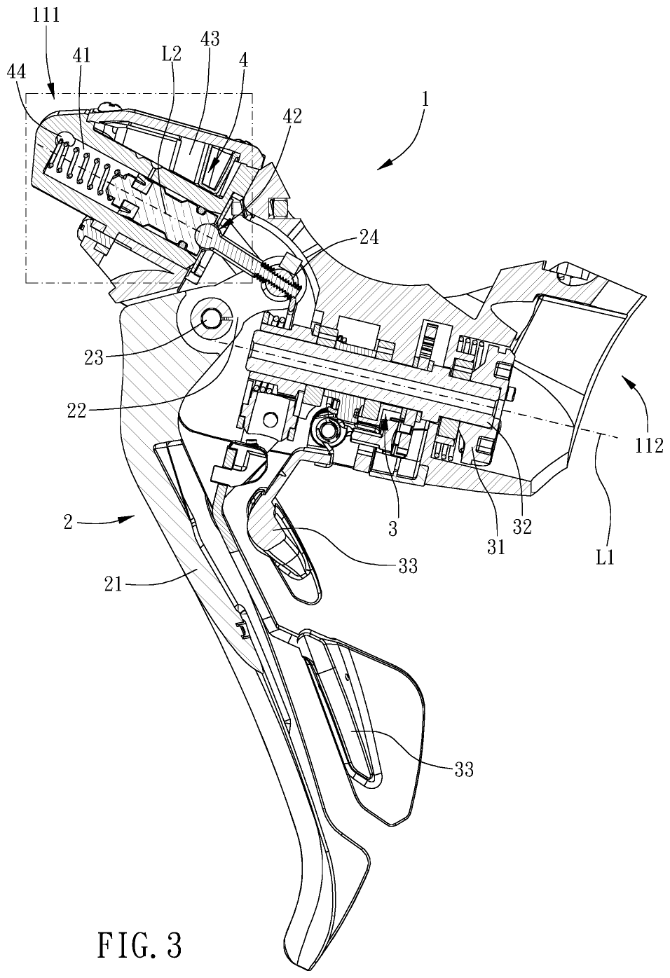

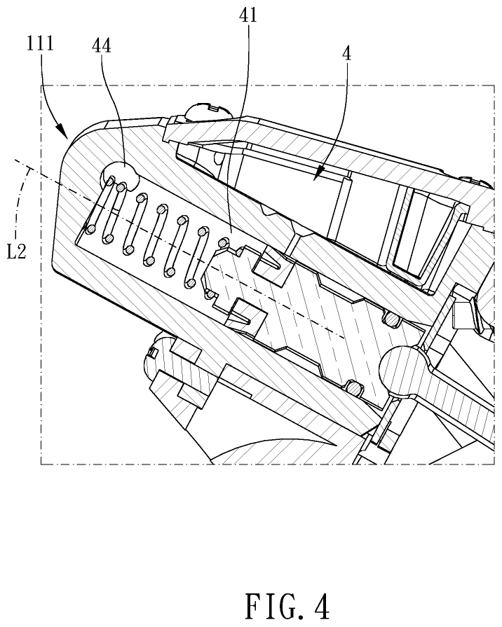

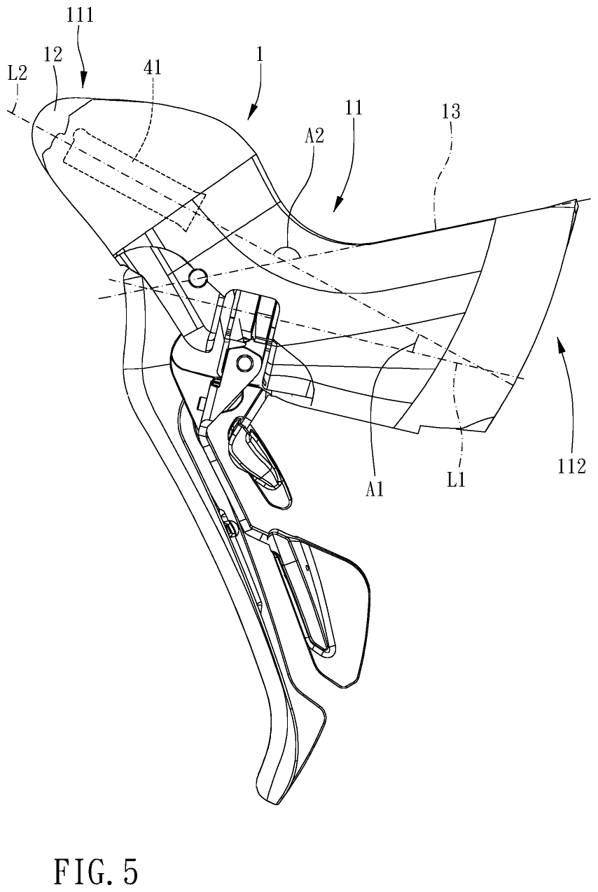

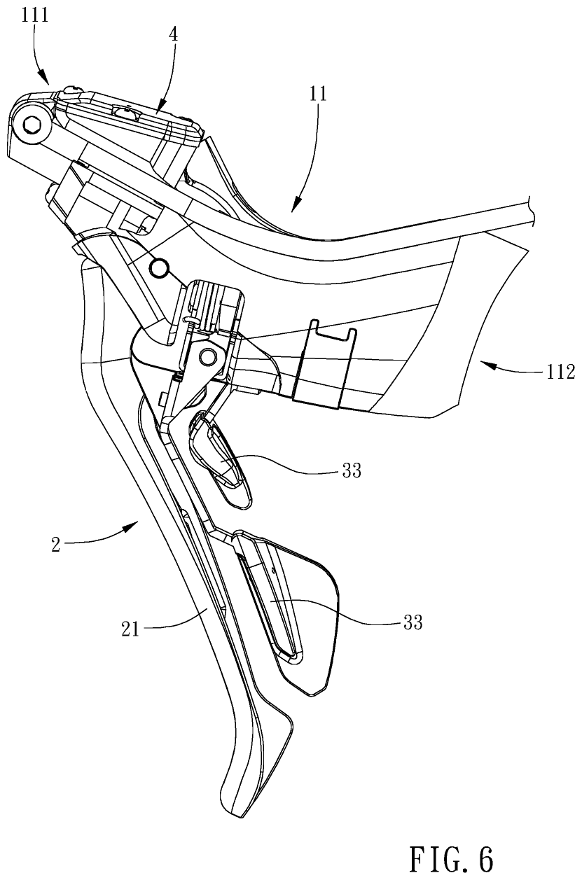

Please refer to FIGS. 1 to 7 for a preferable embodiment of the present invention. A bicycle operating device configured to be mounted to a bended handlebar of a bicycle frame includes a housing 1, a control unit 2, a speed shafting unit 3 and a fluid pressure generating assembly 4.

The housing 1 extends in a first direction, the housing 1 includes a grip portion 11, the grip portion 11 includes a first end portion 111 and a second end portion 112, and an attachment portion 12 is disposed on a first end portion 111 of the grip portion 11.

The control unit 2 is rotatably connected to the housing 1 and adjacent to the 20 first end portion 111.

The speed shafting unit 3 is disposed on the housing 1, the speed shafting unit 3 includes a reel 31, a shaft 32 and at least one lever 33, and the reel 31 is rotatable about a rotation axis L1.

The fluid pressure generating assembly 4 includes a cylinder 41, a piston assembly 42 and a reservoir 43. The control unit 2 drives the piston assembly 42 to move relative to the cylinder 41 to generate a control fluid pressure. The cylinder 41 is disposed on the housing 1 and adjacent to the first end portion 111, the reservoir 43 is located above the cylinder 41, and the piston assembly 42 is movable along a cylinder axis L2 of the cylinder 41. The control unit 2 drives the piston assembly 42 to move along the cylinder axis L2 to generate the control fluid pressure to drive the brake assembly of the bicycle to perform braking. Since the brake assembly is driven by the control fluid pressure to perform braking, it provides a large and reliable braking force compared with the conventional brake assembly on the bended handlebar.

The cylinder axis L2 and the rotation axis L1 define a first included angle A1. Specifically, the cylinder axis L2 and the rotation axis L1 define the first included angle A1 smaller than 20 degrees. In this embodiment, the first included angle A1 is 15 degrees. Since the first included angle A1 is formed between the cylinder axis L2 and the rotation axis L1, the cylinder 41 is not located on a plane that the shaft 32 and the reel 31 are located on, thus reducing the length of the housing 1.

The grip portion 11 includes an inclined surface 13 adjacent to the second end portion 112, and the inclined surface 13 and the cylinder axis L2 define a second included angle A2 ranging from 120 degrees to 160 degrees. In this embodiment, the second included angle A2 is 140 degrees. Since the second included angle A2 is formed between the inclined surface 13 and the cylinder axis L2, the inclined surface 13 is ergonomics and more suitable for users to hold.

The cylinder 41 includes an outlet opening 44, the outlet opening 44 is adjacent to the first end portion 111, the outlet opening 44 is in communication with an outlet port 45, and the outlet port 45 is connected to a hydraulic piping assembly 46. When the control unit 2 drives the piston assembly 42 to move, the piston assembly 42 forces the fluid to flow, via the outlet opening 44, into the hydraulic piping assembly 46, to perform brake.

The control unit 2 includes a press section 21 and a working section 22, the working section 22 includes a first pivot portion 23 and a second pivot portion 24, the first pivot portion 23 is rotatably connected to the housing 1, and the second pivot portion 24 is rotatably connected to the piston assembly 42. When the press section 21 is pressed, the press section 21 drives the working section 22 to swing so that the second pivot portion 24 drives the piston assembly 42 to move. The first pivot portion 23 is located between the press section 21 and the second pivot portion 24 so that the control unit 2 is rotatable about the first pivot portion 23 to drive the second pivot portion 24 to swing.

The piston assembly 42 faces toward the first end portion 111 and projects within the cylinder 41. When the press section 21 is pressed, the press section 21 drives the piston assembly 42 to move in the cylinder 41 inward, for propelling the cylinder 41.

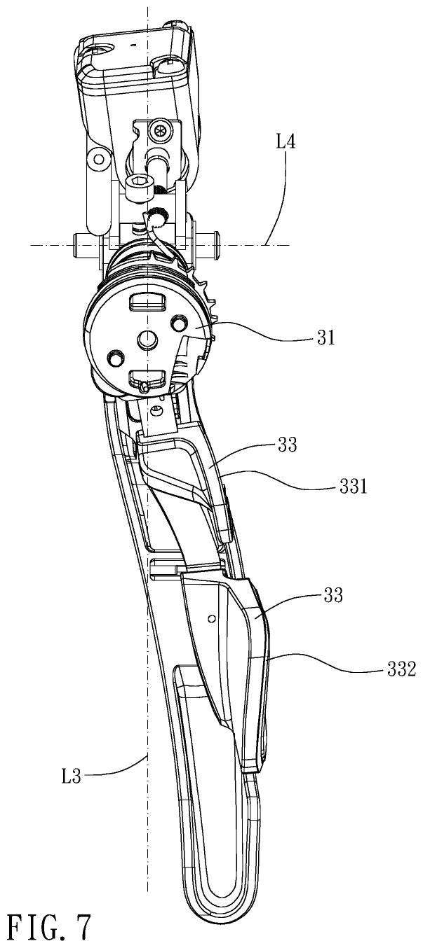

In this embodiment, the fluid pressure generating assembly 4 is located correspondingly above the rotation axis L1, which avoids interference with the speed shafting unit 3. Preferably, the at least one lever includes two levers includes 33, and the two levers 33 control the reel 31 to rotate in opposite directions for controlling gear shifting, respectively. Specifically, as shown in FIG. 7, each of the two levers 33 includes a first press region 331 and a second press region 332, a first reference plane L3 is defined as to be perpendicular to a control axis L4 which the control unit 2 rotates about and to pass a center of the reel 31, and in an un-operated state the first press region 331 and the second press region 332 are located by a side of the first reference plane L1 remote from the bicycle frame. The first press region 331 and the second press region 332 are located by the same side of the first reference plane L3 remote from the bicycle frame, so that the first press region 331 and the second press region 332 can be easier and more convenient to be pressed towards the bicycle frame by the user's index finger or middle finger direction of the bicycle, and so that the first press region 331 and the second press region 332 are independently swingable so that it can prevent the first press region 331 and the second press region 332 from interfering with each other and from affecting the gear shifting.

Although particular embodiments of the invention have been described in detail for purposes of illustration, various modifications and enhancements may be made without departing from the spirit and scope of the invention. Accordingly, the invention is not to be limited except as by the appended claims.

1. A bicycle operating device, including:
a housing, extending in a first direction, the housing including a grip portion, the grip portion including a first end portion and a second end portion, an attachment portion being disposed on a first end portion of the grip portion;
a control unit, rotatably connected to the housing and adjacent to the first end portion, and rotatable about a control axis;
a speed shifting unit, disposed on the housing, including a reel, a shaft and at least one lever, the reel being rotatable about a rotation axis;
a fluid pressure generating assembly, including a cylinder, a piston assembly and a reservoir, wherein the control unit drives the piston assembly to move relative to the cylinder to generate a control fluid pressure, the cylinder is disposed on the housing and adjacent to the first end portion, the reservoir is located above the cylinder, and the piston assembly is movable along a cylinder axis of the cylinder;
wherein the cylinder axis and the rotation axis define a first included angle smaller than 20 degrees;
wherein the at least one lever includes two levers;
wherein the control axis is transverse to the rotation axis, and the two levers are rotatable about the rotation axis;
wherein as viewed in a direction parallel to the control axis, the two levers are arranged to be entirely without overlapping with each other.

2. A bicycle operating device, including:
a housing, extending in a first direction, the housing including a grip portion, the grip portion including a first end portion and a second end portion, an attachment portion being disposed on a first end portion of the grip portion;
a control unit, rotatably connected to the housing and adjacent to the first end portion, and rotatable about a control axis;
a speed shifting unit, disposed on the housing, including a reel, a shaft and at least one lever, the reel being rotatable about a rotation axis;
a fluid pressure generating assembly, including a cylinder, a piston assembly and a reservoir, wherein the control unit drives the piston assembly to move relative to the cylinder to generate a control fluid pressure, the cylinder is disposed on the housing and adjacent to the first end portion, the reservoir is located above the cylinder, and the piston assembly is movable along a cylinder axis of the cylinder;
wherein the cylinder axis and the rotation axis define a first included angle;
wherein the grip portion includes an inclined surface adjacent to the second end portion, and the inclined surface and the cylinder axis define a second included angle ranging from 120 degrees to 160 degrees;
wherein the at least one lever includes two levers;
wherein the control axis is transverse to the rotation axis, and the two levers are rotatable about the rotation axis;
wherein as viewed in a direction parallel to the control axis, the two levers are arranged to be entirely without overlapping with each other.

3. The bicycle operating device of claim 1, wherein the grip portion includes an inclined surface adjacent to the second end portion, and the inclined surface and the cylinder axis define a second included angle ranging from 120 degrees to 160 degrees.

4. The bicycle operating device of claim 1, wherein the cylinder includes an outlet opening, and the outlet opening is adjacent to the first end portion.

5. The bicycle operating device of claim 2, wherein the cylinder includes an outlet opening, and the outlet opening is adjacent to the first end portion.

6. The bicycle operating device of claim 4, wherein the outlet opening is in communication with an outlet port, and the outlet port is connected to a hydraulic piping assembly.

7. The bicycle operating device of claim 5, wherein the outlet opening is in communication with an outlet port, and the outlet port is connected to a hydraulic piping assembly.

8. The bicycle operating device of claim 1, wherein the control unit includes a press section and a working section, the working section includes a first pivot portion and a second pivot portion, the first pivot portion is rotatably connected to the housing, and the second pivot portion is rotatably connected to the piston assembly.

9. The bicycle operating device of claim 2, wherein the control unit includes a press section and a working section, the working section includes a first pivot portion and a second pivot portion, the first pivot portion is rotatably connected to the housing, and the second pivot portion is rotatably connected to the piston assembly.

10. The bicycle operating device of claim 8, wherein the first pivot portion is located between the press section and the second pivot portion.

11. The bicycle operating device of claim 9, wherein the first pivot portion is located between the press section and the second pivot portion.

12. The bicycle operating device of claim 8, wherein the piston assembly faces toward the first end portion and projects within the cylinder, and when the press section is pressed, the press section drives the piston assembly to move in the cylinder inward.

13. The bicycle operating device of claim 9, wherein the piston assembly faces toward the first end portion and projects within the cylinder, and when the press section is pressed, the press section drives the piston assembly to move in the cylinder inward.

14. The bicycle operating device of claim 1, wherein the fluid pressure generating assembly is located above the rotation axis.

15. The bicycle operating device of claim 2, wherein the fluid pressure generating assembly is located above the rotation axis.

16. The bicycle operating device of claim 1, wherein the two levers include a first press region and a second press region, respectively, a first reference plane is defined as to be perpendicular to the control axis and extends through a center of the reel, and in an un-operated state of the speed shifting unit the first press region and the second press region are located by a side of the first reference.

17. The bicycle operating device of claim 2, wherein the two levers include a first press region and a second press region, respectively, a first reference plane is defined as to be perpendicular to the control axis and extends through a center of the reel, and in an un-operated state of the speed shifting unit the first press region and the second press region are located by a side of the first reference.
